(19) United States
(12) Patent Application Publication
(10) Pub. No.: US 2008/0139289 A1
(43) Pub. Date: Jun. 12, 2008

(54) Slot machine and playing method thereof

(75) Inventor: Kazuo Okada, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE GAMING AMERICA, INC., Las Vegas, NV (US)

(21) Appl. No.: 11/790,190

(22) Filed: Apr. 24, 2007

Related U.S. Application Data
(60) Provisional application No. 60/873,577, filed on Dec. 8, 2006.

(51) Int. Cl. G07F 17/34

(52) U.S. Cl. 463/20

(57) ABSTRACT

In a slot machine, as a plurality of specific symbols are selected from among a plurality of symbols by an external operation of player, the plurality of specific symbols thus specified and a game number input by a game number inputter are responded, by displaying an image of data of list of dividends covering occurrences of a prize with respect to those specific symbols, and after a decision of a plurality of selected specific symbols by an external operation of player, this game is followed by execution of a unit game repeated a prescribed number of times, whereby a payout rate of credit is changed depending on the frequency of appearance of the specific symbols on a main display during this game.

### CROSS REFERENCE TO RELATED APPLICATION

This application claims priority to co-pending U.S. provisional patent application Ser. No. 60/873,577 entitled “SLOT MACHINE AND PLAYING METHOD THEREOF” filed on Dec. 8, 2006 and naming Kazuo OKADA as inventor, and which is incorporated by reference herein for all purposes.

### BACKGROUND OF THE INVENTION

1. Field of the Invention

The present invention relates to a slot machine for playing games by using a game medium such as a coin or bill, and a playing method thereof.

2. Description of Related Art

As conventional slot machines, there are those disclosed in U.S. Pat. No. 6,960,133 B1 or U.S. Pat. No. 6,012,983. Those slot machines are each configured for a player to feed a game medium such as a coin or bill to an insertion slot of the slot machine, and input a spin button, whereby a display provided at the front of the machine housing displays a plurality of symbols scrolling thereon, which automatically stop thereafter. In this occasion, by input of the spin button, it is adapted to execute a process for determining symbols to be stopped, in omission, by generating random numbers when starting displaying symbols scrolling. By this process for determination of the symbols to be stopped, if a transfer to a mystery bonus or a bonus game such as a second game is won, it performs a payout of credit or coins associated with a prize such as the mystery bonus, or makes a transition from base game to bonus game to perform the bonus game. And, the slot machine is configured for a progress of game with occurrences of a winning combination to thereby pay out a prescribed dividend.

There is a slot machine disclosed in U.S. Pat. No. 6,093,102, which is adapted to pay out a dividend for symbols arranged on a particular line called “payline”. Further, there is a slot machines disclosed in U.S. Pat. No. 6,604,999 B2, as well as in U.S. Patent No. 2002065124 A1, which is adapted for implementation of two types of payouts, being a payout to be determined by the combination of stopped symbols on a payline, and a payout to be determined by the number of displayed symbols called scatters (referred hereinafter to “scatter symbols”) unaffected by the payline.

The concept of scatter symbol in such a slot machine has triggered a payout by the number.

### SUMMARY OF THE INVENTION

According to a first aspect of the present invention, a slot machine comprises a display adapted to display a plurality of symbols automatically arranged or rearranged, and in rearrangement of the symbols, to graphically display specific symbols preset to be different in between in frequency of appearance on the display, and data of list of dividends preset to give an increased payout rate of credit as the frequency of appearance becomes higher, a select switch capable of a selecting operation for selecting a plurality of specific symbols from among the plurality of symbols, and a controller programmed to execute processes (a) to (e) for

(a) specifying a plurality of specific symbols selected by operation of the select switch,

(b) responding to the plurality of specified specific symbols by generating an image of the data of list of dividends covering occurrences of a prize with respect to those specific symbols,

(c) displaying the generated image on the display,

(d) automatically rearranging a plurality of symbols arranged on the display so that the specific symbols are different in between in the frequency of appearance on the display, and

(e) performing a payout of credit in correspondence to the data of list of dividends for an occurrence of the prize with respect to the specific symbols in a content of display of the plurality of rearranged symbols.

According to a second aspect of the present invention, a slot machine comprises a display adapted to display a plurality of symbols automatically arranged or rearranged, and in rearrangement of the symbols, to graphically display specific symbols preset to be different in between in frequency of appearance on the display, and data of list of dividends preset to give an increased payout rate of credit as the frequency of appearance becomes higher, a select switch capable of a selecting operation for selecting a plurality of specific symbols from among the plurality of symbols, a decision switch capable of a deciding operation for deciding the plurality of specific symbols selected by operation of the select switch, and a controller programmed to execute processes (a) to (f) for

(a) specifying a plurality of specific symbols selected by operation of the select switch,

(b) responding to the plurality of specified specific symbols by generating an image of the data of list of dividends covering occurrences of a prize with respect to those specific symbols,

(c) displaying the generated image on the display,

(d) deciding the plurality of specified specific symbols by operation of the decision switch,

(e) automatically rearranging a plurality of symbols arranged on the display so that the specific symbols are different in between in the frequency of appearance on the display, and

(f) performing a payout of credit in correspondence to the data of list of dividends for an occurrence of the prize with respect to the specific symbols in a content of display of the plurality of rearranged symbols.

According to a third aspect of the present invention, a slot machine comprises a select switch capable of a selecting operation for selecting a plurality of specific symbols from among a plurality of symbols, a decision switch capable of a deciding operation for deciding the plurality of specific symbols selected by operation of the select switch, a game number inputter for inputting a number of games to be executed under a condition with the plurality of specific symbols decided, a display adapted to display a plurality of symbols automatically arranged or rearranged, and in rearrangement of the symbols, to graphically display specific symbols preset to be different in between in frequency of appearance on the display, and data of list of dividends preset to give a payout rate of credit changed depending on the frequency of appearance of specific symbols, and the number of games input by the game number inputter, and a controller programmed to execute processes (a) to (f) for

(a) specifying a plurality of specific symbols selected by operation of the select switch,

(b) responding to the plurality of specified specific symbols by generating an image of the data of list of dividends covering occurrences of a prize with respect to those specific symbols,

(c) displaying the generated image on the display,

(d) deciding the plurality of specified specific symbols by operation of the decision switch,

(e) automatically rearranging, by the number of games input by the game number inputter, a plurality of symbols arranged on the display so that the specific symbols are different in between in the frequency of appearance on the display, and

(f) performing a payout of credit in correspondence to the data of list of dividends for an occurrence of the prize with respect to the specific symbols in a content of display of the plurality of rearranged symbols.

According to a fourth aspect of the present invention, a playing method of a slot machine comprises

(a) a step in which a controller specifies a plurality of specific symbols selected by operation of a select switch,

(b) a step in which the controller responds to the plurality of specified specific symbols by generating an image of data of list of dividends covering occurrences of a prize with respect to those specific symbols,

(c) a step in which the controller displays the generated image on a display,

(d) a step in which the controller automatically rearranges a plurality of symbols arranged on the display so that the specific symbols are different in between in frequency of appearance on the display, and

(e) a step in which the controller performs a payout of credit in correspondence to the data of list of dividends for an occurrence of the prize with respect to the specific symbols in a content of display of the plurality of rearranged symbols.

According to a fifth aspect of the present invention, a playing method of a slot machine comprises

(a) a step in which a controller specifies a plurality of specific symbols selected by operation of a select switch,

(b) a step in which the controller responds to the plurality of specified specific symbols by generating an image of data of list of dividends covering occurrences of a prize with respect to those specific symbols,

(c) a step in which the controller displays the generated image on a display,

(d) a step in which the controller decides the plurality of specified specific symbols by operation of a decision switch,

(e) a step in which the controller automatically rearranges a plurality of symbols arranged on the display so that the specific symbols are different in between in frequency of appearance on the display, and

(f) a step in which the controller performs a payout of credit in correspondence to the data of list of dividends for an occurrence of the prize with respect to the specific symbols in a content of display of the plurality of rearranged symbols.

According to a sixth aspect of the present invention, a playing method of a slot machine comprises

(a) a step in which a controller specifies a plurality of specific symbols selected by operation of a select switch,

(b) a step in which the controller responds to the plurality of specified specific symbols and a number of games input by a game number inputter by generating an image of data of list of dividends covering occurrences of a prize with respect to those specific symbols,

(c) a step in which the controller displays the generated image on a display,

(d) a step in which the controller decides the plurality of specified specific symbols by operation of a decision switch,

(e) a step in which the controller automatically rearranges, by the number of games input by the game number inputter, a plurality of symbols arranged on the display so that the specific symbols are different in between in frequency of appearance on the display, and

(f) a step in which the controller performs a payout of credit in correspondence to the data of list of dividends for an occurrence of the prize with respect to the specific symbols in a content of display of the plurality of rearranged symbols.

### BRIEF DESCRIPTION OF THE DRAWINGS

FIG. 1 is a flow chart schematically showing a playing method of a slot machine according to an embodiment of the present invention.

FIG. 2 is a perspective view showing an appearance of the slot machine according to the embodiment of the present invention.

FIG. 3 is an explanatory diagram showing columns of symbols and code numbers of respective symbols to be displayed on respective display regions of the slot machine according to the embodiment of the present invention.

FIG. 4 is an explanatory diagram showing a payout table for determining a payout rate upon establishment of a combination to be accompanied by a payout.

FIG. 5 is an explanatory diagram showing relationships between symbols selective in a game and their expectation values.

FIGS. 6A and 6B are explanatory diagrams showing payout tables for a game.

FIG. 7 is an explanatory diagram showing an exemplary illustration of a count value/payout rate display.

FIG. 8 is a block diagram showing a control circuit of the slot machine according to the embodiment of the present invention.

FIG. 9 is an explanatory diagram showing an exemplary illustration of an image of dividend list data indicating a payout rate of credit depending on the number of rearranged specific symbols.

FIG. 10 is a flow chart showing part of a procedure of a base game execution process to be executed in the slot machine according to the embodiment of the present invention.

FIG. 11 is a flow chart showing part of the procedure of the base game execution process to be executed in the slot machine according to the embodiment of the present invention.

FIG. 12 is a flow chart showing a procedure of a stop symbol determination process to be executed in the slot machine according to the embodiment of the present invention.

FIG. 13 is a flow chart showing a procedure of a scroll indication process for symbols to be executed in the slot machine according to the embodiment of the present invention.

FIG. 14A is an explanatory diagram showing an exemplary illustration in rearrangement of a combination including a prescribed number of or more specific symbols, FIG. 14B is an explanatory diagram showing an exemplary illustration of a winning combination by specific symbols stopped on a payline, and FIG. 14C is an explanatory diagram showing an exemplary illustration of symbols stopped in display regions including specific symbols.

FIG. 15A is an explanatory diagram showing an exemplary illustration of a symbol selecting display in which respective symbol display regions are turned on, FIG. 15B is an explanatory diagram showing an exemplary illustration of the symbol selecting display after selection of a symbol by a player, and FIG. 15C is an explanatory diagram showing an exemplary illustration of the symbol selecting display when a game is ended.

### DETAILED DESCRIPTION OF THE EMBODIMENT

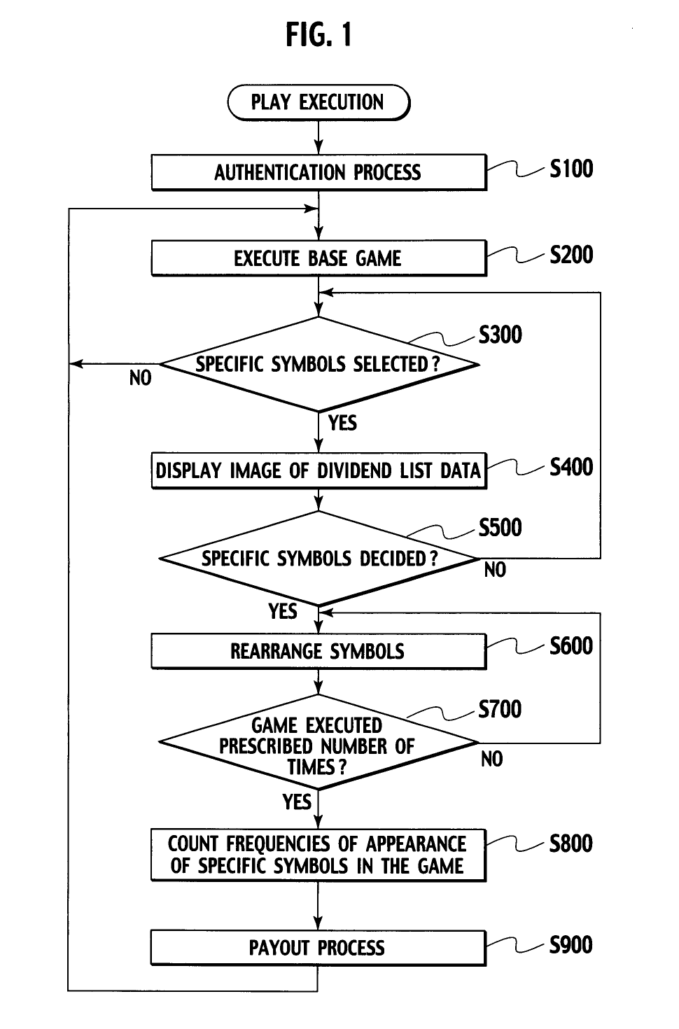

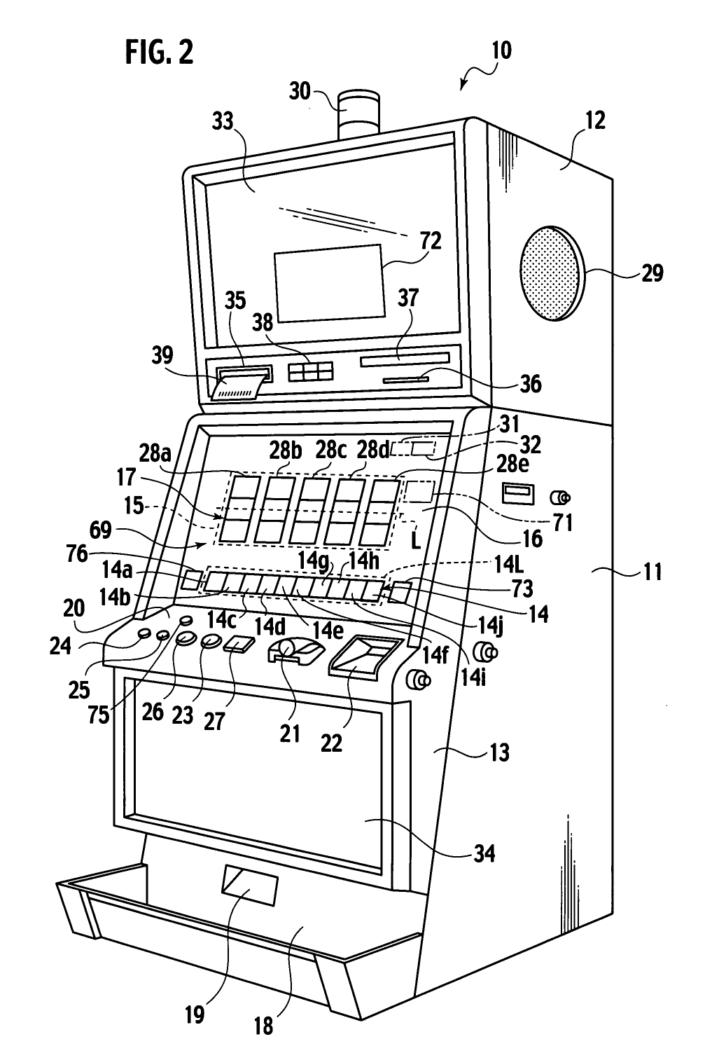

FIG. 1 is a flow chart schematically showing a playing method of a slot machine according to an embodiment of the present invention. There will be described below schematic actions of the slot machine and the playing method according to the embodiment of the present invention, with references made to a flow chart shown in FIG. 1, and a perspective view shown in FIG. 2.

In the slot machine according to the embodiment of the present invention, when the slot machine is started with power applied, it performs an authentication process (step S100). In this authentication process, initial checking processes are carried out as previous steps before entering a unit game, such as if a program for operating the system normally operates, and if any falsification has been made to the program.

Next, a base game is executed (step S200). In this game, it is first judged whether or not one or more specific symbols are selected by a player from among 3 rows by 5 columns of symbols displayed in display regions 28 (refer to FIG. 2) of a liquid crystal display 17 in a display window 15 of a lower image display panel 16 provided at the front of a cabinet 11 (step S300).

The selection of specific symbols by a player in this game can be effected by a symbol selecting display 14 provided below the display window 15, for example. The symbol selecting display 14 has symbol display regions 14a to 14j, where whole symbols “JACKPOT 7”, “BLUE 7”, “BELL”, “CHERRY”, “STRAWBERRY”, “PLUM”, “ORANGE”, “APPLE”, “LOBSTER”, and “CRAB” to be displayed in the display regions 28 (28a to 28e) are displayed. If a player gives (a) selective contact operation(s) to one or more of the symbol display regions 14a to 14j in which symbols are displayed, (an) input signal(s) corresponding to symbol display region(s) 14a to 14j given the contact operation(s) is (are) output from a touch panel 69 provided at the front of the lower image display panel 16. It is noted that in the present embodiment the symbol display regions 14a to 14j are lighted for a colored display in accordance with an expectation value of each symbol. Accordingly, for each symbol, the player is allowed by the color to judge if the expectation value is big or small. The expectation value of symbol will be described later.

In the slot machine according to the present embodiment, the input signal from the touch panel 69 is handled as an external input. And, the symbol display region(s) 14a to 14j given (a) contact operation(s) by a player is (are) discriminated, whereby (a) selected specific symbol(s) can be recognized.

Further, symbol display regions 14a to 14j of the symbol selecting display 14 may be each respectively made up by a pushbutton switch. In this case, any symbol display region 14a to 14j pressed by a player can be discriminated by an input signal from the pushbutton switch. In this case, the input signal from the pushbutton switch corresponds to an external input.

Next, a dividend list data image display 72 displays an image of dividend list data that indicates (a) specific symbol(s) selected by a player, and a payout rate of credit depending on the number of rearranged ones of the specific symbol(s) (the frequency of appearance of the specific symbol(s)) within a prescribed number of times of the game (step S400).

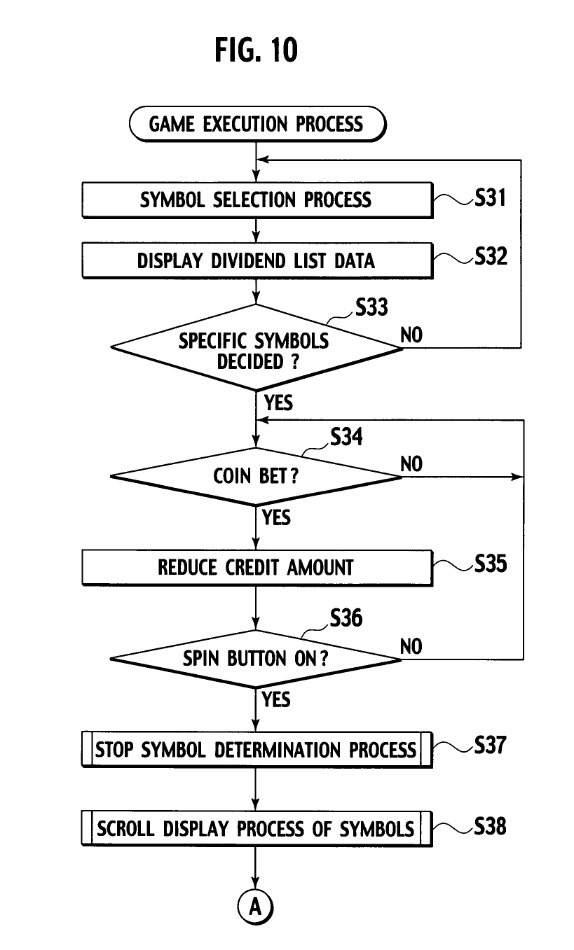

For example, in a case where symbols “PLUM” and “APPLE” are selected as specific symbols, the dividend list data image display 72 displays an image of dividend list data indicating payout rates depending on the number of rearranged ones of the symbols “PLUM” and “APPLE”, as shown in FIG. 9. This dividend list data is preset so as to have an increased payout rate of credit as the frequency of appearance of the specific symbols becomes higher. The player is thus allowed, by selecting one or more specific symbols from the varieties of symbols, to check various payout rates by looking an image of dividend list data, so that the player can devise strategies for how many and which symbols should be selected, while seeing images of dividend list data.

Next, it is judged whether or not the specific symbol(s) is (are) decided by pressing a specific symbol selection deciding button 73, which is made up by a decision switch (step S500). It is noted that unless the specific symbol selection deciding button 73 is pressed, the flow goes to the step S300 to execute a process for specific symbol selection. It therefore is allowed for a player to make reselection of specific symbol(s), while looking an image of dividend list data displayed after a selection of (a) specific symbol(s).

Next, in the case where the selected specific symbol(s) is (are) decided by pressing the specific symbol selection deciding button 73, those symbols arranged in the display regions 28 are rearranged (step S600). That is, under such a condition that (a) coin(s) is (are) inserted into the coin slot 21 by a player and a desired credit amount is bet, the spin button 23 is pressed by a player, which acts as a trigger for symbols arranged in the display regions 28 to start scrolling.

Here, the cabinet 11 has the lower image display panel 16 provided at the front. This lower image display panel 16 is provided with the display window 15, of which inside the liquid crystal display 17 is provided. The liquid crystal display 17 has the display regions 28 (28a to 28e) for displaying a set of 3 rows by 5 columns of symbols. In each display region 28, a symbol is arranged. And now, after lapse of a prescribed time, the scroll stops automatically to have a symbol stopped (rearranged) in each display region 28. In other words, in the base game, five columns of unit games are executed.

Next, it is judged whether or not a prescribed number of times of games (symbol rearrangements) have been executed (step S700). Here, the prescribed number of times of execution of the game (symbol rearrangement) may be a fixed value, or may be designated by a player using a game time number designation button 75 and a game time number display 76. It is noted that in the case of designation of the number of times of game by a player, the designated number of times of game also gives a change to the content of dividend list data indicating (a) payout rate(s) of credit depending on the number of rearranged ones of (a) specific symbol(s). That is, for selection of identical specific symbols, if different game numbers are designated, the payout rate of credit is decreased as the designated game number becomes greater.

And, along a prescribed number of times of execution of symbol rearrangement, for (a) specific symbol(s) selected in the game, a count is made of the frequency of appearance during the game (step S800).

In this game, the frequency of appearance of (a) specific symbol(s) is counted, specifically, in the following manner. Namely, in the slot machine according to the present embodiment, for e.g. “PLUM” and “APPLE” selected in the game, the number of those symbols rearranged in the display regions 28 is counted as the frequency of appearance of the specific symbols.

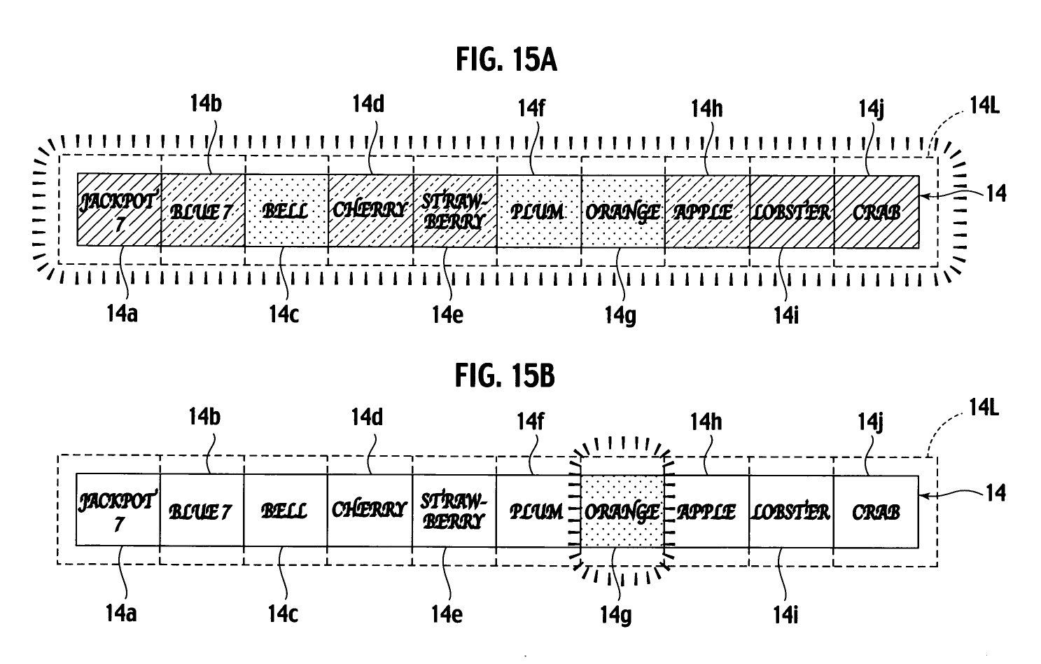

For example, it is assumed that symbols of “PLUM” and “APPLE” are selected as specific symbols. In this case, there is generated a prize accompanying a payout of credit depending on the number of symbols of “PLUM” and “APPLE” rearranged as shown in FIG. 14A.

Further, for a combination to establish a prize accompanying a payout of credit by a symbol of “PLUM” selected in the game, there may be taken, for example, such a case that includes a prescribed number of or more symbols simply of “PLUM” as shown in FIG. 14B.

After finish of a prescribed number of times of symbol rearrangement, the slot machine according to the present embodiment performs a payout of credit by a payout rate depending on a frequency of appearance of (a) specific symbol(s) counted during the game (step S900), and goes to the step S200, where it executes the base game. For example, in the case of symbols of “PLUM” and “APPLE” selected as specific symbols, there is generated a prize accompanying a payout of credit depending on the number of symbols of “PLUM” and “APPLE” rearranged as shown in FIG. 14A.

In the slot machine according to the present embodiment, it is allowed for a player to expect an increased payout rate of credit, as the number of selected specific symbols rearranged in the game as well as the number of times of rearrangement of such (a) specific symbol(s) is increased in the game, with an enhanced interest in the game.

For the foregoing example, description is made of a case of display in which symbols are stopped in a set of 3 rows by 5 columns of display regions 28 (28a to 28e), while the present invention is not limited to the set of 3 rows by 5 columns of display regions 28.

Further, in the foregoing example, a symbol is displayed in each display region 28 by using the liquid crystal display 17. As another example, there may be a configuration which employs mechanical rotation reels shaped cylindrical, having a plurality of symbols indicated on their side faces, and in which the rotation reels are rotated and thereafter stopped, so that symbols are stopped inside the display window 15.

Further, in the foregoing example, the base game is configured to display symbols scrolling in a vertical direction relative to the display regions 28 (28a to 28e) and, thereafter, stop (rearrange) the symbols. As another example, symbols may be changed and displayed (rearranged) in the display regions 28 (28a to 28e).

Description is now made of the configuration of slot machine 10 according to the embodiment of the present invention, with reference made to a perspective view shown in FIG. 2. This slot machine 10 is installed within a gaming facility.

In the slot machine 10, as a game medium to be employed for execution of a unit game, there is a coin, a bill, or electronic valuable information corresponding thereto. However, in the present invention, the game medium is not particularly limited, and may be a medal, token, electronic money, or ticket, for example. It is noted that the above-noted ticket is not particularly limited, and may be, e.g., a bar-coded ticket or the like, as will be described later.

As shown in FIG. 2, the slot machine 10 has a cabinet 11, a top box 12 installed on an upside of the cabinet 11, and a main door 13 provided on a front of the cabinet 11.

Inside the cabinet 11 is provided the liquid crystal display 17, which has 3 rows by 5 columns of scrolling symbols. This liquid crystal display 17 has display regions 28 (28a to 28e) for displaying 3 rows by 5 columns of symbols. In front of the display regions 28, there is disposed the display window 15, through which symbols displayed in the display regions 28 are visible. In execution of the base game, symbols are scrolled in the 3 rows by 5 columns of display regions 28 (28a to 28e). The scrolled symbols are visible to a player, through the display window 15.

In the present embodiment, a main display is exemplified by the set of 3 rows by 5 columns of display regions 28 (28a to 28e) of the liquid crystal display 17. As another example, mechanical reels that have symbols indicated on the side faces may be rotated and stopped, to thereby display symbols through the display window 15. Further, the set of display regions 28 may be other than 3 rows by 5 columns.

Above the main door 13, in front of the liquid crystal display 17, there is provided the lower image display panel 16. This lower image display panel 16 has a transparent liquid crystal panel, and displays thereon various game-related information, rendering images, etc., when playing a game.

On the lower image display panel 16, there are provided a credit amount display 31, a payout amount display 32, and a count value/payout rate display 71. The credit amount display 31 is adapted to display the number of credited coins by an image. The payout amount display 32 is adapted to display, by an image, the number of coins to be paid out when the display regions 28 have stopped therein a combination that includes a prescribed number of (six, for example) or more prescribed symbols. The count value/payout rate display 71 is adapted to display symbols selected in the game, a frequency of appearance thereof, i.e., the number of rearranged symbols (or the number of rearranged times), and a payout rate (in number of pieces) of credit depending on the frequency of appearance.

Further, at a medium stage of the display window 15 provided on the lower image display panel 16, there may be set up a payline L. The payline L defines a combination of symbols. In this case, if the combination of symbols stopped on the payline L is a winning combination, the number of coins to be paid out depends on the winning combination and the number of bet coins (bet amount). The payline L is set as an imaginary one, and actually, invisible. However, it may be actually depicted on the lower image display panel 16.

Further, below the display regions 28 of the lower image display panel 16, there are provided the symbol selecting display 14, the specific symbol selection deciding button 73, and the game time number display 76.

This symbol selecting display 14 has a plurality of symbol display regions 14a to 14j for individually displaying whole symbols that can be displayed by the liquid crystal display 17 in the display regions 28 (28a to 28e), that is, “JACKPOT 7”, “BLUE 7”, “BELL”, “CHERRY”, “STRAWBERRY”, “PLUM”, “ORANGE”, “APPLE”, “LOBSTER”, and “CRAB”. Further, at both sides of this symbol selecting display 14, there are provided the specific symbol selection deciding button 73, which is made up by a decision switch adapted for a player to decide selected specific symbols, and the game time number display 76, which displays the number of times of game designated by a player.

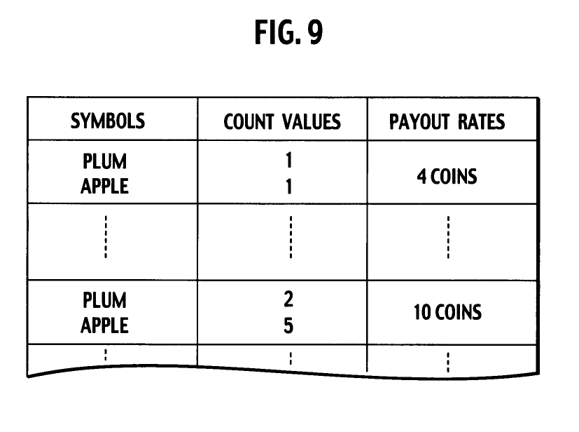

Each symbol display region 14a to 14j has a back light 14L (refer to FIG. 8) disposed at the back, whereby every symbol display region 14a to 14j is adapted for an individual lighted display.

In addition, at the front of the lower image display panel 16, there is provided the touch panel 69 (refer to FIG. 8), allowing for a player to operate the touch panel 69 to thereby input various instructions.

Namely, it is allowed for a player to select (a) specific symbol(s) through the symbol selecting display 14, and concurrently, for a player to decide the selected specific symbol(s) through the specific symbol selection deciding button 73.

Below the lower image display panel 16, there are provided a control panel 20, a coin slot 21 for reception of coin into the cabinet 11, and a bill validator 22.

On the control panel 20, there are provided a spin button 23, a change button 24, a cashout button 25, a 1-bet button 26, a max-bet button 27, and the game time number designation button 75. The spin button 23 is a button to input an instruction for starting scroll of symbols displayed in the display regions 28. The change button 24 is a button to be used when requesting a change to an attendant of the gaming facility. The cashout button 25 is a button to input an instruction for a payout of credited coins to a coin tray 18.

The 1-bet button 26 is a button to input an instruction for betting to a game one coin from among credited coins. The max-bet button 27 is a button to input an instruction for betting to a game a maximal number of (50, for example) coins that can be bet to a single time of game from among credited coins.

The bill validator 22 is adapted to validate whether a bill is a legitimate one or not, and accept a legitimate bill into the cabinet 11. It is noted that the bill validator 22 may be configured to read the bar-coded ticket 39 described later. At a lower front of the main door 13, that is, below the control panel 20, there is provided a berry glass 34 on which a character of the slot machine 10 and the like are drawn.

The game time number designation button 75 is a button for a player to designate the number of times of game execution before or after selection of (a) specific symbol(s). This game time number designation button 75 is adapted to designate a number of times of game depending on the number of times it is pressed by a player. As the designated number of times has an upper limit, such as 20 for example, an adaptation is provided for the return to a first time when the upper limit is reached.

At the front of the top box 12, there is provided an upper image display panel 33. The upper image display panel 33 is provided with a liquid crystal panel for displaying, for example, a rendering image, or an image for introduction to a content of game or description of a rule of game, and has the dividend list data image display 72, which is adapted to display an image of dividend list data that indicates (a) specific symbol(s) selected by a player, and a payout rate of credit depending on the number of rearranged ones of the specific symbol(s) (the frequency of appearance of the specific symbols), during a prescribed number of times of game.

Further, on the top box 12, there is provided a speaker 29 for audio output. Below the upper image display panel 33, there are provided a ticket printer 35, a card reader 36, a data display 37, and a keypad 38. The ticket printer 35 is adapted to print on a ticket a bar code that has encoded data, such as of a credit amount, a date and time, and an identification number of the slot machine 10, and output it as a bar-coded ticket 39. It may be allowed for the player to play a game at another slot machine by using a bar-coded ticket 39, or exchange a bar-coded ticket 39 with bills or such at a cashier or the like in the gaming facility.

The card reader 36 is adapted for reading data from a smart card, and writing data to a smart card. The smart card is a card to be owned by a player, which has stored therein, for example, a data for identification of the player, and data on a history of games the player has done.

The data display 37 is made by a fluorescent display or the like, and adapted to display, for example, data read by the card reader 36, and data input by a player through the keypad 38. The keypad 38 is adapted to input data as well as commands for issuance of a ticket, etc.

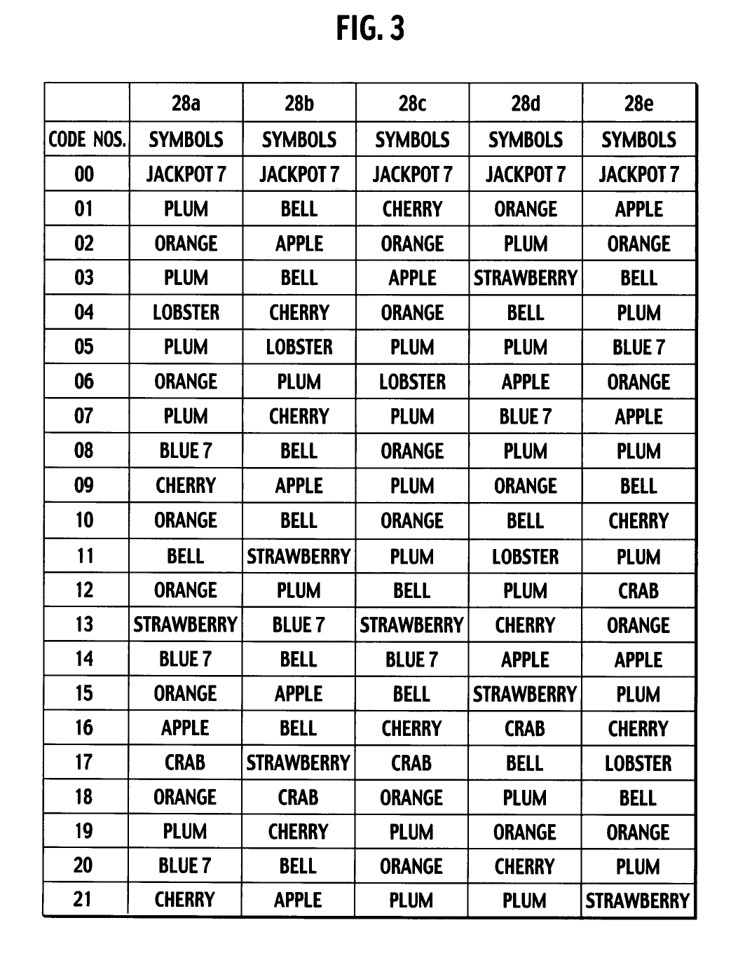

FIG. 3 is an explanatory diagram showing columns of symbols scrolled in respective display regions 28 (28a to 28e) of the liquid crystal display 17. As shown in FIG. 3, the display regions 28 (28a to 28e) are each respectively adapted to scroll a column of a set of symbols composed of a total number of 22 code numbers “00” to “21”. It is noted that the display regions 28 (28a to 28e) have their arrangements of symbols different in between

The set symbols to be displayed in each display region 28 (28a to 28e) is composed of a combination of “JACKPOT 7”, “BLUE 7”, “BELL”, “CHERRY”, “STRAWBERRY”, “PLUM”, “ORANGE”, “APPLE”, “LOBSTER”, and “CRAB” symbols.

It is noted that the payout to be made depends on the frequency of appearance of (a) specific symbol(s) displayed in the display regions 28 (28a to 28e) during a prescribed number of times of game, whereas there may be set combinations accompanying payouts by combinations of symbols displayed on the display regions 28 (28a to 28e).

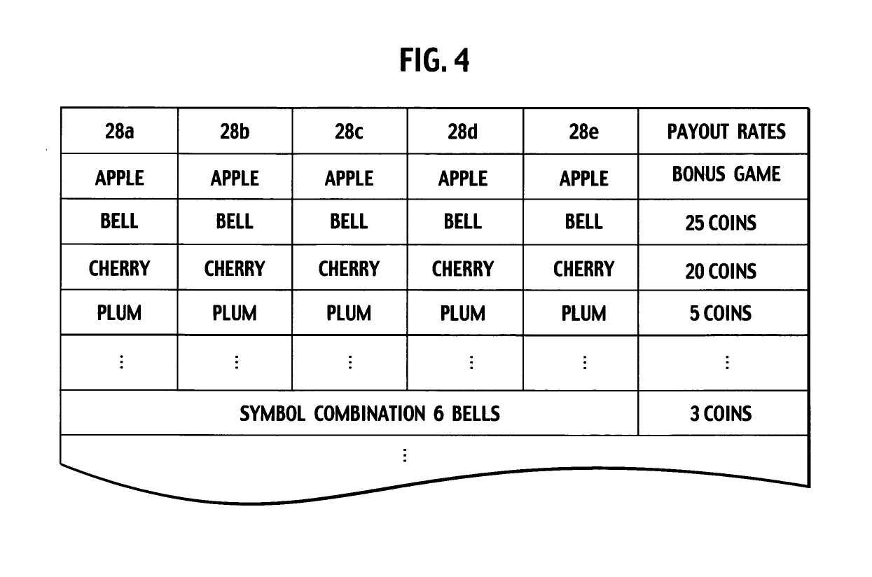

In this case, the combinations accompanying payouts encompass such a combination as a winning combination stopped on the payline L of the display window 15, and a combination including a prescribed number of (e.g. 6) or more “BELL” symbols, for example. And the slot machine 10 has a payout table (refer to FIG. 4) set for a payout amount (as the payout rate) to be determined upon establishment of a combination accompanying a payout.

The symbols displayed (arranged) in the display regions 28 (28a to 28e) start scrolling, when the spin button 23 is pressed after the 1-bet button 26 or the max-bet button 27 is pressed. With lapse of a prescribed time after the start of scroll of symbols, the symbols are automatically stopped (rearranged). At this time, in each display region 28 (28a to 28e), any symbol out of a column of symbols shown in FIG. 3 is stopped.

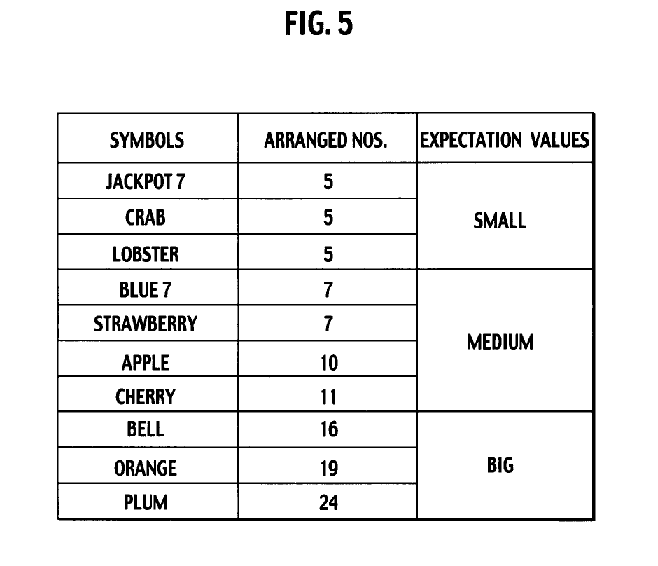

FIG. 5 is an explanatory diagram showing relationships between symbols selective in a game and their expectation values. In FIG. 5, the arranged numbers show total numbers, that is, totals of numbers of symbols set for the columns of symbols (refer to FIG. 3). In FIG. 5, for symbols from “BLUE 7” that has an arranged number of 7 to “CHERRY” that has an arranged number of 11, an expectation value of payout is set as “medium”. Then, for symbols that have a smaller arranged number than the “medium”, an expectation value of payout is set as “small”, and for symbols that have greater arranged numbers than the “medium”, an expectation value of payout is set as “big”. The expectation value of payout indicates the magnitude of the possibility for a prize accompanying a payout of credit to occur by rearrangement of the symbol. It thus so follows that for symbols low of arranged number, the expectation value of payout gets small, and for symbols high of arranged number, the expectation value of payout gets great. In FIG. 5, the expectation value is defined as “big”, “medium”, or “small” for a facilitated description, it however is noted that the expectation value may be numerically expressed for each symbol. For example, for the “APPLE” that has an arranged number of 10, the expectation value may be set to 100, and in this case, for the “JACKPOT 7” having an arranged number of 5, the expectation value may be 50, and for the “PLUM” having an arranged number of 24, the expectation value may be 240.

As described, the symbol display regions 14a to 14j are lighted for a colored display in accordance with the expectation value of each symbol. There is assigned an identical color to symbols of an identical expectation value. There may be a color coding, for example, such that symbols of a “small” expectation value may be “red”, symbols of a “medium” expectation value, “yellow”, and symbols of a “big” expectation value, “blue”. The color coding will constitute a measure when a player selects a symbol. Accordingly, when expecting the higher payout subject to a low probability of payout, the player may well select a symbol displayed “red”. Further, when expecting the more steady payout subject to non-expectant high payouts, the player may well select a symbol displayed “blue”. Although, in this example, description is made of a color coding of three kinds of color being “red”, “yellow”, and “blue”, the color may be more specifically coded for each and every expectation value.

It is noted that in the slot machine according to the invention, the relationships between symbols selected in a game and their expectation values are not limited to examples of FIG. 5. For instance, in the case of a configuration using the liquid crystal display 17 for displaying symbols in the display regions 28, there may be provided a set of particular symbols having a single arranged number, simply when a game is executed.

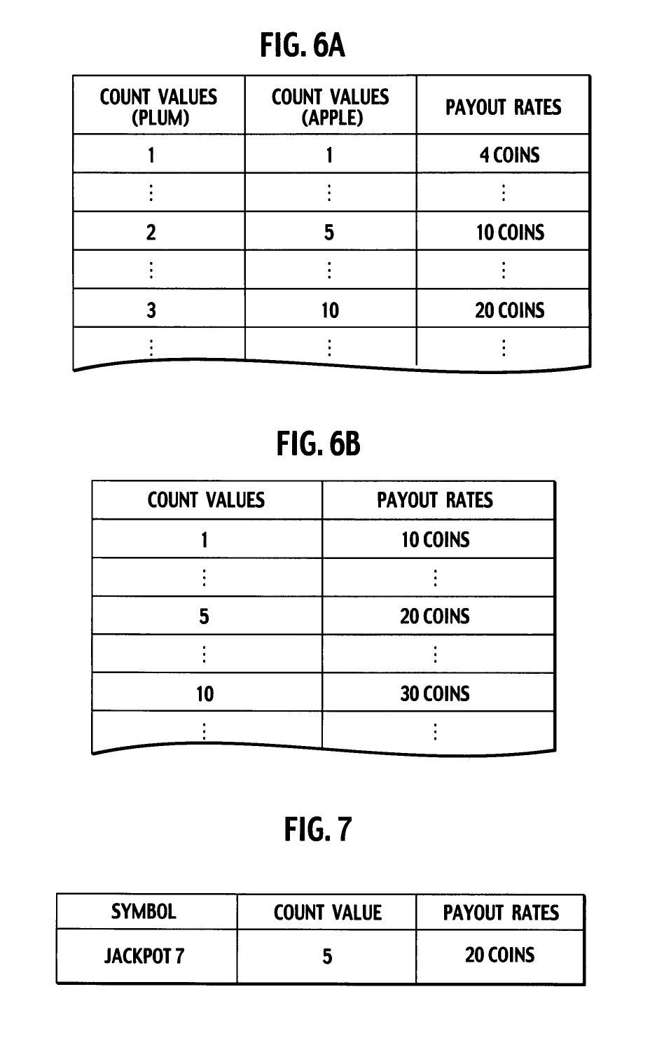

FIG. 6A and FIG. 6B are diagrams showing payout tables (game-oriented payout tables) set for respective symbols in a game. The game-oriented payout tables are selective when a game is executed. In the game-oriented payout tables, the term “count value” is an aggregate of the number of times a symbol selected by a player is displayed in the display regions 28 (28a to 28e) during a prescribed number of times of symbol rearrangement. For example, letting the prescribed number of times be e.g. 5, if a symbol selected by a player is rearranged one at the first time of symbol rearrangement, two at the second time of symbol rearrangement, one at the third time of symbol rearrangement, two at the fourth time of symbol rearrangement, and one at the fifth time of symbol rearrangement, then the count value becomes “7”.

For instance, it is now assumed that “PLUM” and “APPLE” symbols are selected as specific symbols. In this case, there occurs a prize accompanying a payout of credit in dependence on the number of times such “PLUM” and “APPLE” symbols are rearranged as shown in FIG. 14A.

It is noted that in description of the present embodiment, there are exemplified a payout table for “PLUM” of a “big” expectation value and “APPLE” of a “medium” expectation value (refer to FIG. 6A), and a payout table for “JACKPOT 7” of a “small” expectation value. Also for symbols else than shown in FIG. 6A or FIG. 6B, their payout tables are set.

Here is set in advance a payout of credit depending on the expectation value. In other words, such a setup is made in advance that the payout rate of credit increases as the frequency of appearance of (a) specific symbol(s) becomes higher. More specifically, in cases including “JACKPOT 7” of a “small” expectation value, the possibility of occurrence of a prize accompanying a payout of credit is low, and the payout is set to be greater than cases including “APPLE” of a “medium” expectation value as well as “PLUM” of a “big” expectation value. Further, in cases including “PLUM” of a “big” expectation value, the possibility of occurrence of a prize accompanying a payout of credit is high, and the payout is set to be smaller than cases including “APPLE” of a “medium” expectation value as well as “JACKPOT 7” of a “small” expectation value.

Accordingly, in the case of a selection made of a symbol having a small expectation value, the player can expect a greater payout subject to a lower possibility of payout. Further, in selection of a symbol having a big expectation value, subject to non-expectant great payouts, the possibility of payout becomes high, allowing for expectation of an ensured payout. In particular, in cases in which a plurality of specific symbols are selected, if the selection is made of symbols small of expectation value, then a very great payout is expectable subject to a very low possibility of payout, but on the contrary, if symbols big of expectation value are selected, then no more than a very small payout is expectable subject to a very high possibility of payout. It is noted that in the case of a number of times of game designated by a player, changes occur in the payout table showing a payout rate of credit depending on the number of rearranged specific symbols, depending on even the designated number of times of game, as well.

Such being the case, the payout to be provided can be enriched in variety by selection of a plurality of specific symbols, and variety-rich payouts are displayed as dividend list data on the dividend list data image display 72 described later, which gives more choices to a player, exciting the interest in finding out which combination of specific symbols should be selected to obtain a greater payout.

It is noted that in the slot machine according to the invention, the composition of payout tables set up for each and every symbol is not limited to examples of FIG. 6A and FIG. 6B.

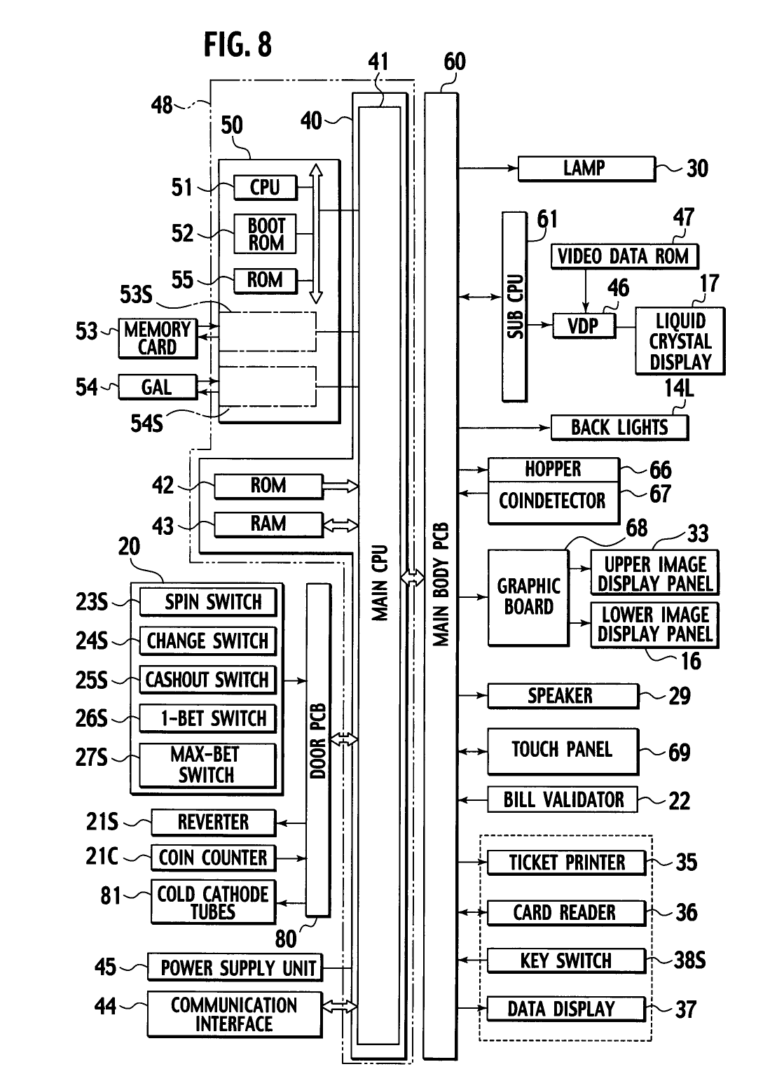

FIG. 7 is an explanatory diagram showing an exemplary illustration of a count value/payout rate display 71. As an example, here is taken a case of “JACKPOT 7” selected by a player in a game. As shown in FIG. 7, the count value/payout rate display 71 is adapted to display thereon a “symbol name” selected in the game, a “count value” at that time, and a “payout rate” of credit corresponding to that count value. It may however be sufficient for the content of display on the count value/payout rate display 71 to cover at least “count value” and “payout rate”.

The payout of credit for a game is performed at the time when whole symbol rearrangements are finished. For example, in the case of a symbol rearrangement to be consecutively repeated 10 times, the payout is to be made of a credit depending on a count value at the time when the tenth symbol rearrangement is finished. It therefore is allowed for a player to always recognize a current count value and payout rate during a game, and confirm a final count value and payout rate when the game is ended. It is noted that a payout of credit for a game may be performed each time when the game is ended.

For example, in the case of “JACKPOT 7” selected by a player in a game, the payout table shown in FIG. 6B is selected. And, if the symbol selected in the game is rearranged three in the first time of game, and two in the second time of game, the count value at this time is “5”. The count value/payout rate display 71 then displays thereon the count value “5” as of the time when the second time of game is ended, and a payout rate of credit to be “20”. In such a content of display, the “count value” and “payout rate” are updated every time when a single time of game is ended. Such being the case, the content to be displayed is updated every time when a single time of game is ended, thereby allowing a player to exactly grasp a current “count value” and “payout rate”. This allows for expectation such that the player may want a greater payout, so that the player may have a maintained enthusiasm for the game.

Further, the display of “count value” and “payout rate” by the count value/payout rate display 71 may be performed every time when (a) symbol(s) selected by a player is (are) rearranged. In this case, in each game, unless the symbol(s) selected by a player is (are) rearranged, the “count value” and “payout rate” will not be displayed. It therefore is allowed for a player to recognize, by absence or presence of display, whether or not (a) selected symbol(s) is (are) rearranged, that is, whether or not a payout is to be caused by (a) selected symbol(s). Further, in the case of rearrangement even of a single selected symbol, there is given a display by the count value/payout rate display 71, which allows for expectation such that a player may feel interest in what numerical values are indicated, so that the player may have a maintained enthusiasm for the game.

FIG. 8 is a block diagram showing a control circuit of the slot machine 10 shown in FIG. 2. As shown in FIG. 8, the control circuit is made up by such components as a mother board 40, a main body PCB (printed circuit board) 60, a gaming board 50, a sub CPU 61, a door PCB 80, and various types of switches and sensors, etc. And, the mother board 40 and the gaming board 50 cooperatively constitute a controller 48.

The gaming board 50 has a CPU (central processing unit) 51, a ROM 55, and a boot ROM 52 mutually connected through an internal bus, as well as a card slot 53S corresponding to a memory card 53, and an IC socket 54S corresponding to a GAL (generic array logic) 54.

The memory card 53 has a game program and a game system program stored therein. The game program includes a stop symbol determination program. The stop symbol determination program is a program for determining symbols (code numbers corresponding to the symbols) to be stopped on the payline L of the display regions 28 (28a to 28e).

Further, the memory card 53 has stored therein an image of dividend list data indicating (a) specific symbol(s) selected by (a) player(s) during a prescribed number of times of game, and (a) payout rate(s) of credit depending on the number of rearranged ones of the specific symbol(s) (the frequency of appearance of the specific symbol(s)). It is noted that the image of dividend list data may be stored in the ROM 55.

Further, the card slot 53S is configured for possible insertion and removal of the memory card 53, and is connected to the mother board 40 by an IDE bus. Consequently, by removing the memory card 53 from the card slot 53S, writing another game program together with a game system program to the memory card 53, and inserting the memory card 53 into the card slot 53S, the type as well as the content of the game to be played on the slot machine 10 can be changed.

The game program includes a program relating to the progress of game, and a program for a transfer to a bonus game. Further, the game program contains video data as well as audio data to be output in the game.

The GAL 54 has a plurality of input ports and output ports, and is adapted, with data input to the input ports, to output data corresponding to those data from the output ports. An output data from an output port constitutes a data for setting the payout rate described.

Further, the IC socket 54S is configured for possible attachment and detachment of the GAL 54, and is connected to the mother board 40 by a PCI bus. Consequently, by detaching the GAL 54 from the IC socket 54S, rewriting a program stored in the GAL 54, and attaching the GAL 54 to the IC socket 54S, a data to be output from the GAL 54 for setting the payout rate can be changed.

The CPU 51, ROM 55, and boot ROM 52 mutually connected by the internal bus are connected to the mother board 40 by a PCI bus. The PCI bus is responsible for transmission of signals between the mother board 40 and the gaming board 50, as well as for power supply from the mother board 40 to the gaming board 50. The ROM 55 has country identification information and an authentication program stored therein. The boot ROM 52 has stored therein a preliminary authentication program, a (boot code) program for the CPU 51 to start the preliminary authentication program, and the like.

The authentication program is a program (falsification checking program) for authenticating the game program and the game system program. The authentication program is a program to perform checks for and verification of no falsification made to the game program and the game system program. Namely, the authentication program is written along a procedure for authentication of the game program and the game system program. The preliminary authentication program is a program for authenticating the authentication program described. The preliminary authentication program is written along a procedure for proving that the authentication program as the object to be authenticated is not falsified, that is, for authentication of the authentication program.

The mother board 40 has a main CPU 41, a ROM (read only memory) 42, a RAM (random access memory) 43, and a communication interface 44.

The main CPU 41 has functions for controlling an entirety of the slot machine 10. In particular, the main CPU 41 is adapted, when the spin button 23 is pressed after a credit is bet by a player, for a control to output to the sub CPU 61 a command signal for scrolling symbols arranged in the display regions 28 (28a to 28e) of the liquid crystal display 17, and a control after symbols in the display regions 28 (28a to 28e) are scrolled, to determine symbols to be stopped there. There will be described below functions of the controller 48 including the main CPU 41.

The controller 48 is adapted for control of an execution of the base game to scroll a plurality of symbols arranged in a main display (the liquid crystal display 17), and thereafter to rearrange them as a new symbol matrix. For this, the controller 48 is adapted for execution of a rearrangement control to select from among a plurality of symbols, and decide, symbols to be arrayed into the symbol matrix, and have the decided symbols stopped from the scrolling state.

Further, the controller 48 is adapted, in execution of the base game, for execution of a control to generate a payout when (a) specific symbol(s) is (are) rearranged as (a) target(s) of the payout in the display regions 28 (28a to 28e) of the liquid crystal display 17.

Namely, the controller 48 is adapted for control of an execution of game to select, by (an) external input(s), (a) specific symbol(s) accompanying a payout of credit, as follows. It executes a lighting control for the back light 14L, which can be turned on and off separately by parts corresponding to the symbol display regions 14a to 14j, to be once whole lit at a time in a start of the game, in order for a player to select (a) specific symbol(s) by (a) contact operation(s) to (a) respective symbol display region(s) 14a to 14j of the symbol selecting display 14.

Further, the controller 48 is adapted, in order to display a specific symbol selected by a player, for execution of a lighting control under a condition that a part of the back light 14L corresponding to a single symbol display region given a contact operation of the player, “PLUM” symbol display region 14f, for example, is left as it is lit, to render those parts of the back light 14L corresponding to the remaining symbol display regions 14a to 14e and 14g to 14j whole extinct. When a specific symbol is selected by a contact operation of a player, a code number (refer to FIG. 3) of that symbol is stored in the RAM 43.

Concurrently therewith, the controller 48 displays on the dividend list data image display 72 an image of dividend list data indicating the specific symbol(s) selected by a player, and (a) payout rate(s) of credit depending on the number of rearranged ones of the specific symbol(s) (the frequency of appearance of the specific symbol(s)).

Then, if the specific symbol selection deciding button 73 is pressed by a player, the controller 48 makes a decision of the specific symbol(s) selected by a player.

Further, the controller 48 is adapted, after selection of (a) specific symbol(s) along execution of a game, for control of an execution of the game to scroll a plurality of symbols arranged in the main display (liquid crystal display 17), and rearrange them as a new symbol matrix. For this, an adaptation is made for execution of a rearrangement control to select from among a plurality of kinds of symbols, and decide, symbols to be arrayed into the symbol matrix, and have the decided symbols stopped from the scrolling state. Further, the controller 48 is adapted, during a prescribed number of times of symbol rearrangement, for execution of a control to change the payout rate of credit depending on the frequency of appearance on the main display (liquid crystal display 17) with respect to the specific symbol(s) selected by a player. Namely, it is adapted for a control to increase the payout rate of credit, as the number of rearranged ones of the specific symbol(s) on the main display is increased. Or, it may be adapted for a control to increase the payout rate of credit, as the number of times of rearrangement of the specific symbol(s) on the main display increases.

Further, the controller 48 is adapted, during a prescribed number of times of symbol rearrangement, for execution of a control to display on the count value/payout rate display 71 (a) specific symbol(s) selected by a player, the number of rearranged ones (or the number of times of rearrangement) of the symbol(s) on the main display, and a payout rate of credit depending on the number of rearranged ones (or the number of times of rearrangement). In addition, it is adapted for a control to update and display the contents of such display every time when the game is ended, or every time when the specific symbol(s) is (are) rearranged on the main display.

Further, the controller 48 is adapted during a prescribed number of times of game, if the specific symbol(s) is (are) (a) symbol(s) having (a) small expectation value(s) of payout, for a control to render the payout rate of credit depending on the frequency of appearance of the symbol(s) higher than symbols having (a) big expectation value(s) of payout, and if the specific symbol(s) is (are) (a) symbol(s) having (a) big expectation value(s) of payout, for a control to render the payout rate of credit depending on the frequency of appearance of the symbol(s) lower than symbols having (a) small expectation value(s) of payout.

Further, the controller 48 is adapted, in the case where a prescribed number of times of execution of a game (symbol rearrangement) is designated by a player using the game time number designation button 75 and the game time number display 76, for a control to switch the payout table and the dividend list data, in order to change the payout rate of credit depending on the number of rearranged ones of (a) specific symbol(s) also by the designated number of times of the game so that, for a different number of game times subject to selection of (an) identical specific symbol(s), the payout rate of credit is decreased as the designated number of game times is increased.

The ROM 42 has stored therein programs, such as a BIOS (basic input/output system), to be executed by the main CPU 41, and data for permanent use. As the BIOS is executed by the main CPU 41, processes for initializing peripherals are carried out, entering a process for reading a game program and a game system program stored in the memory card 53, via the gaming board 50. Further, the ROM 42 has stored therein data of game-oriented payout tables shown in FIG. 6A and FIG. 6B. Such data are read in accordance with the game in execution as well as (a) symbol(s) selected by a player.

The RAM 43 has stored therein programs as well as data to be used when the main CPU 41 implements a process.

The communication interface 44 serves for communications, such as with a host computer installed in the gaming facility, via communication channels.

Further, the mother board 40 has later-described main body PCB (printed circuit board) 60 and door PCB 80 each respectively connected thereto by a USB (universal serial bus). In addition, a power supply unit 45 is connected to the mother board 40. With power supplied from the power supply unit 45 to the mother board 40, the main CPU 41 of the mother board 40 is started, supplying power to the gaming board 50 via PCI bus, causing the CPU 51 to start.

The main body PCB 60 and the door PCB 80 have connected thereto apparatuses and devices for generating input signals to be input to the main CPU 41, and apparatuses and devices whose actions are controlled by control signals output from the main CPU 41. The main CPU 41 executes, in accordance with input signals input to the main CPU 41, the game program and the game system program stored in the RAM 43, whereby it implements calculation processes to be performed for storage of their results to the RAM 43, as well as processes for sending control signals to respective apparatuses or devices, as control processes for the apparatuses or devices.

The main body PCB 60 has connected thereto the sub CPU 61, a hopper 66, a coin detector 67, a graphic board 68, the speaker 29, the touch panel 69, the bill validator 22, the ticket printer 35, the card reader 36, a key switch 38S, the data display 37, a lamp 30, and the back light 14L.

The sub CPU 61 is adapted for a control to scroll symbols in the 5 columns of display regions 28 (28a to 28e) set in the liquid crystal display 17, and is connected to a VDP (video display processor) 46.

The VDP 46 reads video data of symbols stored in a video data ROM 47, and generates scroll images to be displayed on the liquid crystal display 17, outputting the scroll images to the liquid crystal display 17.

The hopper 66 is installed in the cabinet 11, for paying out a prescribed number of coins from a coin payout opening 19 to a coin tray 18, in accordance with a control signal output from the main CPU 41. The coin detector 67 is provided inside the coin payout opening 19, and upon a detection of payout of a prescribed number of coins from the coin payout opening 19, outputs an input signal to the main CPU 41.

The graphic board 68 is adapted for controls to display images on the upper image display panel 33 and the lower image display panel 16 in accordance with control signals output from the main CPU 41. Namely, for the lower image display panel 16, it controls display of images other than turning on and off parts of the backlight 14L corresponding to symbol display regions 14a to 14j of the symbol selecting display 14, as well as display of color-coded symbols in the symbol display regions 14a to 14j, and symbols to be displayed in the display regions 28 (28a to 28e).

The credit amount display 31 of the lower image display panel 16 displays thereon a total credit amount stored in the RAM 43. Further, the payout rate display 32 of the lower image display panel 16 displays thereon the number of coins to be paid out. In addition, the count value/payout rate display 71 of the lower image display panel 16 displays thereon (a) symbol(s) selected in a game, the number of rearranged ones (or the number of times of rearrangement) of the symbol(s), and (a) payout rate(s) of credit depending thereon. Further, the graphic board 68 has a VDP for generating video data in accordance with a control signal output from the main CPU 41, a video RAM for temporary storage of video data generated by the VDP, etc.

The dividend list data image display 72 of the upper image display panel 33 displays thereon, in a prescribed number of times of game, an image of dividend list data indicating (a) specific symbol(s) selected by a player, and (a) payout rate(s) of credit depending on the number of rearranged ones (the frequency of appearance) of the specific symbol(s).

The bill validator 22 reads an image of bill, and accepts a legitimate bill into the cabinet 11. Further, upon acceptance of a legitimate bill, the bill validator 22 outputs an input signal to the main CPU 41 in accordance with the amount of that bill. The main CPU 41 stores in the RAM 43 a credit amount corresponding to the amount of bill informed by the input signal.

The ticket printer 35 follows a control signal output from the main CPU 41, to print on a ticket a bar code having encoded data such as on a credit amount stored in the RAM 43, and a date and time, as well as an identification number of the slot machine 10, and output it as the bar-coded ticket 39.

The card reader 36 performs reading a data from a smart card, for transmission to the main CPU 41, as well as writing a data to a smart card in accordance with a control signal output from the main CPU 41. The key switch 38S is provided on the keypad 38, and upon operation of the keypad 38 by a player, outputs an input signal to the main CPU 41.

The data display 37 displays a data read by the card reader 36 as well as a data input by a player through the keypad 38, in accordance with a control signal output from the main CPU 41.

To the door PCB 80 has connected thereto the control panel 20, a reverter 21S, a coin counter 21C, and cold cathode tubes 81. On the control panel 20, there are provided a spin switch 23S corresponding to the spin button 23, a change switch 24S corresponding to the change button 24, a cashout switch 25S corresponding to the cashout button 25, a 1-bet switch 26S corresponding to the 1-bet button 26, and a max-bet switch 27S corresponding to the max-bet button 27. The switches 23S to 27S are each respectively adapted, upon operation of a corresponding one of the buttons 23-27 by a player, to output an input signal to the main CPU 41.

The coin counter 21C is installed inside the coin slot 21, and validates whether or not a coin inserted into the coin slot 21 is legitimate. Any coin else than a legitimate one is ejected from the coin payout opening 19. Further, the coin counter 21C is adapted, upon detection of a legitimate coin, to output an input signal to the main CPU 41.

The reverter 21S is adapted to operate in accordance with a control signal output from the main CPU 41, for distribution of coins recognized as legitimate coins by the coin counter 21C to a cash box installed inside the slot machine 10, or to the hopper 66. Namely, when the hopper 66 is filled with coins, legitimate coins are distributed to the cash box by the reverter 21S. On the other hand, unless the hopper 66 is filled with coins, legitimate coins are distributed to the hopper 66.

The cold cathode tubes 81 function as back lights installed at the back of the lower image display panel 16 and the upper image display panel 33, and are adapted to turn on in accordance with a control signal output from the main CPU 41.

Description is now made of specific processes to be implemented in the slot machine 10. After the authentication process shown in FIG. 1, the slot machine 10 reads in sequence the game program and the game system program, to enter execution of the base game, as follows. It is noted that before the execution of base game, the controller 48 performs an initial setting. In this initial setting, the controller 48 resets to a zero a count value M of a counter that indicates the number of stopped ones of (a) specific symbol(s) selected by a player, that is, a stopped symbol number counter of the RAM 43. Further, it resets to a zero a count value N of an execution time number counter of the RAM 43 that indicates the number of times of execution of game.

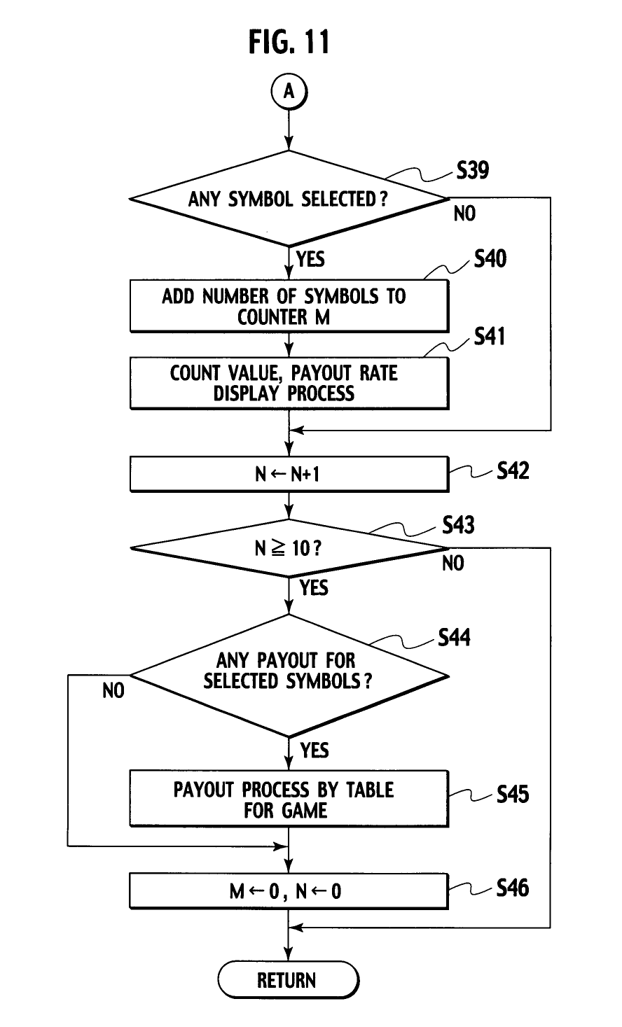

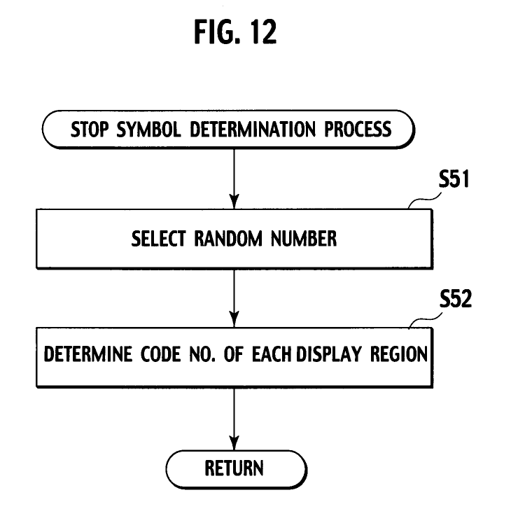

FIG. 10 and FIG. 11 are flow charts showing specific procedures of the base game execution process shown in FIG. 1.

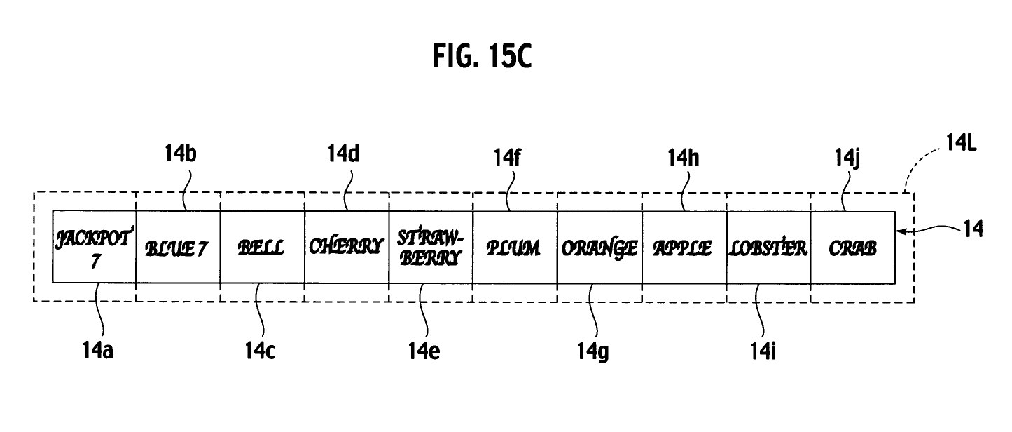

In the game execution process, the controller 48 first executes a symbol selection process (step S31). This symbol selection process corresponds to the game in the description of step S300 of FIG. 1. And, in the symbol selection process, the controller 48 first turns on whole parts of the back light 14L to render lit respective symbol display regions 14a to 14j of the symbol selecting display 14, as shown in FIG. 15A. Each symbol is then lit for a color-coded display in accordance with the expectation value. FIG. 15A shows an example of color-coding by “red”, “yellow”, and “blue” corresponding to expectation values “big”, “medium”, and “small” shown in FIG. 5. Such a color-coded lighting display allows a player to discriminate the expectation value of each symbol with ease.

Next, given (a) contact operation(s) by a player to the touch panel 69, it detects the contact position(s), and recognizes (a) symbol(s) selected by the player.

Continuously, excepting (a) part(s) corresponding to the symbol(s) selected by a player, as shown in FIG. 15B, the controller 48 turns off other parts of the back light 14L. And, a lit state is held simply in (a) symbol display region(s) 14a (14b to 14j) corresponding to the symbol(s) selected by a player. For the following description of the present embodiment, it is assumed that symbol “PLUM” is selected by a player.

Next, the controller 48 executes a process for displaying an image of dividend list data (step S32). Namely, the controller 48, as it has recognized the symbol selected by a player, reads from the memory card 53 an image of dividend list data indicating, for a prescribed number of times of game, the specific symbol selected by a player, and payout rates of credit corresponding to the numbers of rearranged ones of the specific symbol (the frequencies of appearance of the specific symbol), and displays it on the dividend list data image display 72 in the upper image display panel 33, via the main body PCB 60 and the graphic board 68.

If symbols of “PLUM” and “APPLE” are selected as specific symbols, for example, the controller 48 displays on the dividend list data image display 72 an image of dividend list data that indicates, as shown in FIG. 9, payout rates of credit corresponding to the numbers of rearranged ones of the symbols “PLUM” and “APPLE”. It therefore is allowed for a player to select a single specific symbol or a plurality of specific symbols from among various symbols, checking a payout rate of credit being thereby changed in a various manner, by looking the image of dividend list data, so that the player can devise strategies for how many and which symbols should be selected, while seeing images of dividend list data.

Next, the controller 48 judges whether or not the specific symbol is decided by the specific symbol selection deciding button 73 being pressed (step S33). Unless the specific symbol selection deciding button 73 is pressed, then the controller 48 is put in a waiting state for an input of specific symbol selection. It therefore is allowed for a player to remake a selection of specific symbol, seeing an image of dividend list data displayed after a selection of specific symbol.

And, in the case the specific symbol selection deciding button 73 is pressed, a specific symbol is decided, allowing a transfer to a subsequent step S34.

That is, the controller 48 judges whether or not (a) coin(s) is (are) bet (step S34). In this process, the controller 48 makes a judgment as to whether or not a reception is made of an input signal to be output from the 1-bet switch 26S when the 1-bet button 26 is pressed by a player, or an input signal to be output from the max-bet switch 27S when the max-bet button 27 is pressed by a player. In the case of judgment that no coin is bet by a player, it again goes to the step S34.

On the other hand, if it is judged at the step S34 that (a) coin(s) is (are) bet by a player, the controller 48 executes a process for reducing a credit amount stored in the RAM 43, depending on the number of bet coins (step S35). It is noted that if the number of coins being bet is greater than the credit amount stored in the RAM 43, the flow again goes to the step S34, without entering the process for reducing the credit amount stored in the RAM 43. Further, if the number of coins being bet exceeds an upper limit (50 in this embodiment) that can be bet to a single time of play, the flow goes to a step S36, without entering the process for reducing the credit amount stored in the RAM 43. Under this condition, the display regions 28 (28a to 28e) are adapted to display scrolling symbols.

Next, the controller 48 judges whether of not the spin button 23 is turned on by a player (step S36). In this process, the controller 48 makes a judgment as to whether or not a reception is made of an input signal to be output from the spin switch 23S when the spin button 23 is turned on by a player.

Unless it is judged that the spin button 23 is turned on by a player, the flow again goes to the step S34. It is noted that unless the spin button 23 is turned on by a player (for example, in the case the spin button 23 is not turned on by a player, and an instruction for ending the game is input), the controller 48 cancels a result of subtraction at the step S35.

For the present embodiment, description is made of the case of execution of a process (step S35) for reducing the credit amount after (a) coin(s) is (are) bet by a player (step S34), before the judgment of whether or not the spin button 23 is turned on by a player (step S36). However, the present invention is not limited to this example. For instance, after (a) coin(s) is (are) bet by a player (step S34), it may be judged whether or not the spin button 23 is turned on by a player (step S36), and in the case of judgment that the spin button 23 is turned on by a player (YES at the step S36), the flow may enter the process for a subtraction from the credit amount (step S35).

Then, in the case it is judged at the step S36 of FIG. 10 that the spin button 23 is turned on by a player, the controller 48 executes a stop symbol determination process (step S37). In this stop symbol determination process, the controller 48 executes a stop symbol determination program stored in the RAM 43, to thereby determine symbols to be displayed through the display window 15, at the time when symbols are stopped in the display regions 28 (28a to 28e). A combination of symbols to be stopped on the payline L is thereby determined.

Next, the controller 48 executes a scroll display process of symbols (step S38). This is a process to, e.g., have symbols start scrolling in the display regions 28 (28a to 28e), and to stop symbols in the display regions 28 (28a to 28e) after the start of symbol scroll, so that the symbols determined at the step S37 stop.

Next, after execution of the process at the step S38 where symbols are caused to start scrolling and stop in the display regions 28 (28a to 28e), the controller 48 judges whether or not the specific symbol “PLUM” selected by a contact operation to the touch panel 69 by a player is included in the symbols stopped in the display regions 28 (28a to 28e) (step S39).

And, if the symbol “PLUM” selected by a player is included in the symbols stopped in the display regions 28 (28a to 28e) as shown in FIG. 14C (YES at the step S39), the number of (3 in FIG. 14C) symbols of the “PLUM” selected by a player is added (aggregated) to the count value M of the stop symbol number counter in the RAM 43 (step S40).

Continuously thereto, the controller 48 refers to a game-oriented payout table corresponding to the symbol of “PLUM” selected by a player, acquires a current count value and a payout rate corresponding to the count value, and displays them on the count value/payout rate display 71 in correspondence to the symbol selected by a player (step S41). In the present embodiment, this count value/payout rate display process is executed each time when a single time of symbol rearrangement is finished. Consequently, on the count value/payout rate display 71, the displayed content is updated every time when a single time of symbol rearrangement is finished.

Then, after an increment of “1” to the count value N of the execution time number counter in the RAM 43 indicating the number of times of execution of symbol rearrangement (step S42), the controller 48 judges whether or not the count value N of the execution time number counter has reached a prescribed value (10 in this embodiment), that is, whether or not the game is executed a prescribed number of times (10 times in this embodiment) (step S43).

In the case of a count value N of the execution time number counter having reached 10 (YES at the step S43), concluding that the number of times of execution of the game has reached 10, the controller 48 judges whether or not a payout for the specific symbol selected by a player has occurred during the ten times of game (step S44). In an occurrence of payout, by application of a game-oriented payout table corresponding to the symbol “PLUM” selected by a player, it executes a payout process corresponding to the count value M of the stop symbol number counter in the RAM 43 (step S45). It is noted that the prescribed number of times of execution of game (symbol rearrangement) may be fixed (10 times) as described, or designated by a player using the game time number designation button 75 and the game time number display 76. It is noted that in the case of a designation of game time number by a player, the designated game time number also is responded by a variation in content of the dividend list data indicating a payout rate of credit depending on the number of rearranged ones of (a) specific symbol(s). That is, in the case a selection of (an) identical specific symbol(s) for designated game time numbers different in between, the payout rate of credit is decreased, as the designated game time number increases. Further, the process for a designation of game time number by a player is executed before or after the symbol selection process at the step S31.

Then, the controller 48 resets to zero the count value M of the stop symbol number counter and the count value N of the execution time number counter in the RAM 43. Further, as shown in FIG. 15C, it turns off whole parts of the back light 14L, rendering extinct the symbol display regions 14a to 14j of the symbol selecting display 14 (step S46), for the game to be ended, to again go to the base game execution process.

It is noted that when storing (a) coin(s) to be paid out, the controller 48 adds a prescribed amount of credit to the credit amount stored in the RAM 43. Further, for a payout of coins, the controller 48 sends a control signal to the hopper 66 to pay out a prescribed number of coins. The coin detector 67 then serves for counting the number of coins paid out from the hopper 66, and sends a payout completion signal to the controller 48 when that count value has reached a designated number. By this, the controller 48 stops driving the hopper 66, to end the coin payout process.

Therefore, in the slot machine 10 according to the present embodiment, as it has established conditions for starting a game, (a) specific symbol(s) is (are) selected by a player, and thereafter, the game is executed up to ten times, where the number of rearranged ones of the specific symbol(s) increases, which is responded by an increase in payout rate of credit for the symbols.

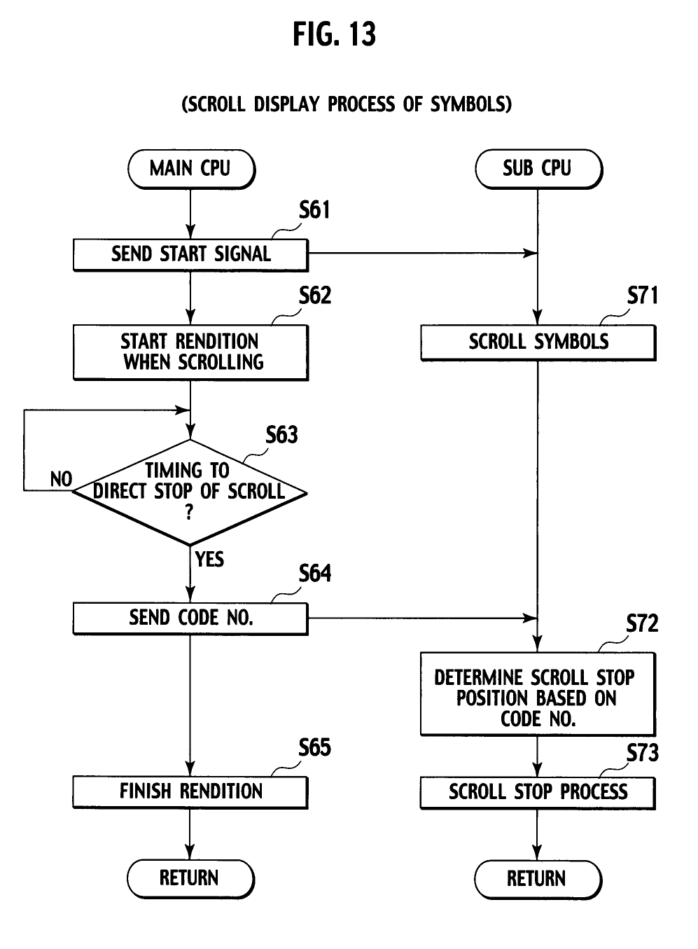

Next, description is made of the stop symbol determination process shown at the step S37 in FIG. 10, with reference to a flowchart shown in FIG. 12.

The flowchart of FIG. 12 shows a procedure of the stop symbol determination process shown at the step S37 in FIG. 10. This process is implemented by the controller 48 in execution of a stop symbol determination program stored in the RAM 43.

First, the controller 48 executes a random number generating program included in the stop symbol determination program. Then, from within a numeral range of 0 to 255, it selects random numbers corresponding to the columns of display regions 28 (28a to 28e) (step S51).

Next, the controller 48 refers to a symbol weighing data corresponding to a payout ratio setting data output from the GAL 54 and stored in the RAM 43. Then, based on selected five random numbers, it determines code numbers (refer to FIG. 3) of the display regions 28 (28a to 28e) (step S52).

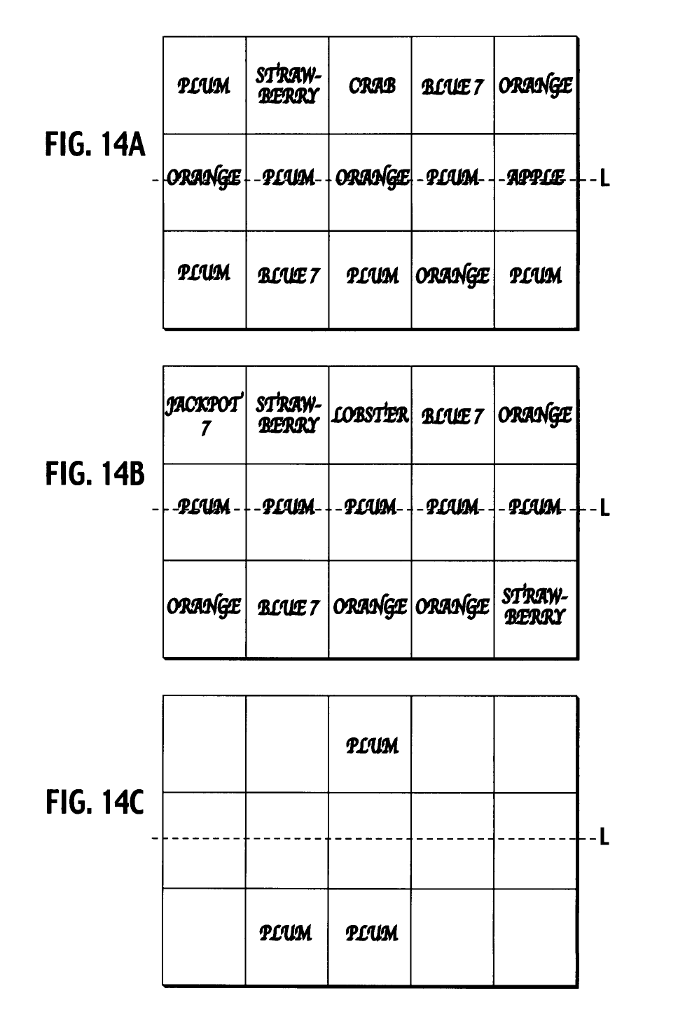

FIG. 13 is a flowchart showing a symbol scroll display process shown at the step S38 in FIG. 10. This process is a process to be implemented by and between the controller 48 and the sub CPU 61.

First, the controller 48 sends to the sub CPU 61 a start signal for the effect to start displaying scroll of symbols in the display regions 28 of the liquid crystal display 17 (step S61). Having received the start signal from the controller 48, the sub CPU 61 outputs a symbol scroll display command to the VDP 46. The VDP 46 reads video data of symbols stored in the video data ROM 47, to have symbols scroll in the five columns of display regions 28 (28a to 28e) of the liquid crystal display 17 (step S71). Thereby, symbols start scrolling in the five columns of display regions 28 (28a to 28e).

After transmission of the start signal to the sub CPU 61 at the step S61 in FIG. 13, the controller 48 executes a rendition along with scroll of symbols (step S62). This process is for display of images onto the lower image display panel 16, audio outputs from the speaker 29, and the like to be executed over a period (e.g. 3 sec.) determined in dependence on a result of the stop symbol determination process (step S37 in FIG. 10) or such.

Next, the controller 48 judges whether or not it is a timing to instruct a stop of the scroll (step S63 in FIG. 13).

Unless it is judged in the process at the step S63 that it is the timing to instruct a stop of the scroll, the flow again goes to the step S63 for a continued rendition along with the scroll of symbols. If it is judged in the process at the step S63 that it is the timing to instruct a stop of the scroll, the controller 48 sends to the sub CPU 61 code numbers of symbols having been stored in the RAM 43 (step S64). Having received the code numbers of symbols from the controller 48, the sub CPU 61 determines stop positions of scroll in correspondence to those code numbers (step S72).

Thereafter, a scroll stopping process is executed, where symbols are stopped and displayed in the display regions 28 (28a to 28e) (step S73). Further, the rendition video display process by the controller 48 is finished (step S65).

Further, the slot machine 10 according to the present embodiment is adapted, when (a) specific symbol(s) selected by a player is (are) (a) symbol(s) having (a) small expectation value(s) of payout, for a control to render the payout rate of credit depending on the number of rearranged ones of the symbol(s) higher than (a) symbol(s) having (a) big expectation value(s) of payout, and when the specific symbol(s) selected by a player is (are) (a) symbol(s) having (a) big expectation value(s) of payout, for a control to render the payout rate of credit depending on the number of rearranged ones of the symbol(s) lower than (a) symbol(s) having (a) small expectation value(s) of payout. It thus so follows that in the case (a) symbol(s) having (a) small expectation value(s) is (are) selected by a player, there might be the greater payout of credit to be received, depending on the number of rearranged ones of the symbol(s), subject to a decreased probability of payout. Such being the case, for a player who likes a game having a greater element of gambling, there might be an expectation to receive a greater payout of credit, allowing the player to have an enhanced interest in the game. Further, in the case (a) symbol(s) having (a) big expectation value(s) is (are) selected by a player, there might be the more exact payout of credit to be received, as the probability of payout is increased. Such being the case, for a player who does not like games having a greater element of gambling, there might be an expectation to receive a more exact payout of credit, allowing the player to have an enhanced interest in the game.

Further, the slot machine 10 according to the present embodiment is adapted, every time when a single time of game is ended, to update the contents of display on the count value/payout rate display 71, allowing a player to exactly grasp “count value” and “payout rate” at a current time. It can thus be expected for the player to desire the greater payout, allowing the player to have a maintained enthusiasm to the game.

Further, in the case of a configuration to update the contents of display on the count value/payout rate display 71 each time when (a) symbol(s) selected by a player is (are) rearranged, it is allowed for a player to recognize by absence or presence of display whether or not the selected symbol(s) is (are) rearranged, that is, whether or not a payout has occurred by the selected symbol(s). Further, as a display is given if the selected symbol(s) is (are) rearranged, even by a single one, it can be expected for the player to desire the greater payout, allowing the player to be interested in what values are indicated, thus having a maintained enthusiasm to the game.

Further, for the slot machine 10 according to the present embodiment, description is made of an example of control for the payout rate of credit to be increased, as the number of rearranged ones of (a) specific symbol(s) selected by a player increases. As another embodiment, there may be adaptation for a control to increase the payout rate of credit in accordance with an increase in the number of times (a) specific symbol(s) selected by a player is (are) rearranged in the display regions 28. In this case, the frequency of appearance of (a) symbol(s) is counted in terms of the number of times of game, so that the count value is held “1” in the first time of game, irrespective of how many the symbols selected by a player are rearranged. Therefore, even in the case of a game executed ten times, the count value will not exceed the maximum of “10”. In this case, a count value of “1” stands with as few as a single symbol rearranged, even if the symbol has a small expectation value. It thus so follows that subject to the count values to be identical, that one of the symbols which has a smaller expectation value gives a higher payout rate, so that the symbol having a smaller expectation value may be selected for a raised probability to receive a greater payout of credit, allowing for a player to have an enhanced enthusiasm for the game.

In the above, an embodiment of the slot machine according to the present invention have been described, but they are simply specific examples, with no particular intentions to limit the present invention, and specific configurations of respective means or such can be appropriately changed in design. Further, description of effects in the embodiment of the present invention is a simple iteration of most preferable effects arising from the present invention, and effects of the present invention are not limited to the described effects in the embodiments of the present invention.

For example, according to the present invention, a controller 48 may be configured as a CPU for execution of a process following a program, like the controller 48 of the mother board 40 as well as the CPU 51 of the gaming board 50 in the slot machine 10 according to the present embodiment, while it is not limited thereto, and part of the controller 48 may be made up by, e.g., a custom IC (integrated circuit) such as an ASIC (application specific integrated circuit), or by a DSP (digital signal processor).

What is claimed is:

1. A slot machine, comprising:
a display adapted
to display a plurality of symbols automatically arranged or rearranged, and
in rearrangement of the symbols, to graphically display
specific symbols preset to be different in between in frequency of appearance on the display, and
data of list of dividends preset to give an increased payout rate of credit as the frequency of appearance becomes higher;
a select switch capable of a selecting operation for selecting a plurality of specific symbols from among the plurality of symbols; and
a controller programmed to execute processes (a) to (e) for
(a) specifying a plurality of specific symbols selected by operation of the select switch,
(b) responding to the plurality of specified specific symbols by generating an image of the data of list of dividends covering occurrences of a prize with respect to those specific symbols,
(c) displaying the generated image on the display,
(d) automatically rearranging a plurality of symbols arranged on the display so that the specific symbols are different in between in the frequency of appearance on the display, and
(e) performing a payout of credit in correspondence to the data of list of dividends for an occurrence of the prize with respect to the specific symbols in a content of display of the plurality of rearranged symbols.

2. A slot machine, comprising:
a display adapted
to display a plurality of symbols automatically arranged or rearranged, and
in rearrangement of the symbols, to graphically display
specific symbols preset to be different in between in frequency of appearance on the display, and
data of list of dividends preset to give an increased payout rate of credit as the frequency of appearance becomes higher;
a select switch capable of a selecting operation for selecting a plurality of specific symbols from among the plurality of symbols;
a decision switch capable of a deciding operation for deciding the plurality of specific symbols selected by operation of the select switch; and
a controller programmed to execute processes (a) to (f) for
(a) specifying a plurality of specific symbols selected by operation of the select switch,
(b) responding to the plurality of specified specific symbols by generating an image of the data of list of dividends covering occurrences of a prize with respect to those specific symbols,
(c) displaying the generated image on the display,
(d) deciding the plurality of specified specific symbols by operation of the decision switch,
(e) automatically rearranging a plurality of symbols arranged on the display so that the specific symbols are different in between in the frequency of appearance on the display, and
(f) performing a payout of credit in correspondence to the data of list of dividends for an occurrence of the prize with respect to the specific symbols in a content of display of the plurality of rearranged symbols.

3. A slot machine, comprising:
a select switch capable of a selecting operation for selecting a plurality of specific symbols from among a plurality of symbols;
a decision switch capable of a deciding operation for deciding the plurality of specific symbols selected by operation of the select switch;
a game number inputter for inputting a number of games to be executed under a condition with the plurality of specific symbols decided;
a display adapted
to display a plurality of symbols automatically arranged or rearranged, and
in rearrangement of the symbols, to graphically display
specific symbols preset to be different in between in frequency of appearance on the display, and
data of list of dividends preset to give a payout rate of credit changed depending on
the frequency of appearance of specific symbols, and
the number of games input by the game number inputter; and
a controller programmed to execute processes (a) to (f) for
(a) specifying a plurality of specific symbols selected by operation of the select switch,
(b) responding to the plurality of specified specific symbols by generating an image of the data of list of dividends covering occurrences of a prize with respect to those specific symbols,
(c) displaying the generated image on the display,
(d) deciding the plurality of specified specific symbols by operation of the decision switch,
(e) automatically rearranging, by the number of games input by the game number inputter, a plurality of symbols arranged on the display so that the specific symbols are different in between in the frequency of appearance on the display, and
(f) performing a payout of credit in correspondence to the data of list of dividends for an occurrence of the prize with respect to the specific symbols in a content of display of the plurality of rearranged symbols.

4. A playing method of a slot machine, comprising:
(a) a step in which a controller specifies a plurality of specific symbols selected by operation of a select switch,
(b) a step in which the controller responds to the plurality of specified specific symbols by generating an image of data of list of dividends covering occurrences of a prize with respect to those specific symbols,
(c) a step in which the controller displays the generated image on a display,
(d) a step in which the controller automatically rearranges a plurality of symbols arranged on the display so that the specific symbols are different in between in frequency of appearance on the display, and
(e) a step in which the controller performs a payout of credit in correspondence to the data of list of dividends for an occurrence of the prize with respect to the specific symbols in a content of display of the plurality of rearranged symbols.

5. A playing method of a slot machine, comprising:
(a) a step in which a controller specifies a plurality of specific symbols selected by operation of a select switch,
(b) a step in which the controller responds to the plurality of specified specific symbols by generating an image of data of list of dividends covering occurrences of a prize with respect to those specific symbols,
(c) a step in which the controller displays the generated image on a display,
(d) a step in which the controller decides the plurality of specified specific symbols by operation of a decision switch,
(e) a step in which the controller automatically rearranges a plurality of symbols arranged on the display so that the specific symbols are different in between in frequency of appearance on the display, and
(f) a step in which the controller performs a payout of credit in correspondence to the data of list of dividends for an occurrence of the prize with respect to the specific symbols in a content of display of the plurality of rearranged symbols.

6. A playing method of a slot machine, comprising:
(a) a step in which a controller specifies a plurality of specific symbols selected by operation of a select switch,
(b) a step in which the controller responds to the plurality of specified specific symbols and a number of games input by a game number inputter by generating an image of data of list of dividends covering occurrences of a prize with respect to those specific symbols,
(c) a step in which the controller displays the generated image on a display,
(d) a step in which the controller decides the plurality of specified specific symbols by operation of a decision switch,
(e) a step in which the controller automatically rearranges, by the number of games input by the game number inputter, a plurality of symbols arranged on the display so that the specific symbols are different in between in frequency of appearance on the display, and
(f) a step in which the controller performs a payout of credit in correspondence to the data of list of dividends for an occurrence of the prize with respect to the specific symbols in a content of display of the plurality of rearranged symbols.
